(19) United States
(12) Patent Application Publication
(10) Pub. No.: US 2012/0137041 A1
(43) Pub. Date: May 31, 2012

(54) NETBOOK SYNCHRONIZATION CHIP DEVICE

(75) Inventor: Johnny Hsiang-Yu CHEN, Santa Ana, CA (US)

(73) Assignee: I O INTERCONNECT, LTD., Santa Ana, CA (US)

(21) Appl. No.: 13/367,361

(22) Filed: Feb. 6, 2012

Related U.S. Application Data
(63) Continuation-in-part of application No. 12/641,593, filed on Dec. 18, 2009.

(51) Int. Cl. G06F 13/20

(52) U.S. Cl. 710/313

(57) ABSTRACT

The present invention discloses a netbook synchronization chip device for data communication and power line connection between a netbook and an external device, including: a first USB interface, coupled to a USB host of the netbook; a second USB interface, coupled to the external device; a memory unit, used for buffering transmission data and storing an application software and a firmware, wherein the application software can be downloaded and executed by the netbook and the external device to transform a peripheral device into a USB device with an accessible root directory; and a synchronization chip controller, used for identifying the external device and performing data communication and power line connection between the netbook and the external device according to the firmware.

### CROSS REFERENCE TO RELATED APPLICATIONS

This application is a Continuation-In-Part of pending U.S. patent application Ser. No. 12/641,593, filed Dec. 18, 2009 and entitled “NETBOOK SYNCHRONIZATION CHIP DEVICE”, the entirety of which is incorporated by reference herein.

### BACKGROUND OF THE INVENTION

1. Field of the Invention

The present invention relates to a data synchronization device for a small-sized portable computer, and more particularly to a netbook synchronization chip device for a netbook to maintain data synchronization with an external device and obtain external charging power.

2. Description of the Related Art

To reduce the price and to increase the portability, the netbook computer usually removes some peripheral devices to feature a small form factor. However, the memory capacity and the data transmission capacity of the netbook computer are then limited. Besides, with the small form factor, the battery capacity provided inside is also limited. A netbook user, for example a salesperson who needs to bring the netbook computer outdoors for visiting clients, may need to transfer the related files to his company's computer to keep the data synchronized after he returns to his office.

Further, due to the limited battery capacity, the netbook needs to be charged from time to time. However, the general netbook, with only a limited number of peripheral devices, has limited ability to communicate with a personal computer for data synchronization; and if the charger is not available when the netbook needs to be charged, it is also irritating for the user. Therefore, there needs a low cost means for the netbook to cope with the problems of data synchronization and battery charging without increasing the form factor.

### BRIEF SUMMARY OF THE INVENTION

In regard to the related problems of the netbook, the present invention proposes a solution capable of simultaneously fulfilling the requirements of data synchronization and battery charging of the netbook.

One objective of the present invention is to provide a netbook synchronization chip device, which facilitates a netbook to synchronize the data with an information processing device via USB interfaces.

Another objective of the present invention is to provide a netbook synchronization chip device, which facilitates a netbook and an information processing device to share peripheral devices of each other.

Still another objective of the present invention is to provide a netbook synchronization chip device, which facilitates a netbook to access a USB device.

Still another objective of the present invention is to provide a netbook synchronization chip device, which facilitates a netbook to obtain charging power from an information processing device.

Still another objective of the present invention is to provide a netbook synchronization chip device, comprising an application program, which can be downloaded and executed by a netbook and an information processing device to transform the data format of the hard drive to be compatible with the FAT32 format.

Still another objective of the present invention is to provide a netbook synchronization chip device, which facilitates a netbook and an information processing device to share peripheral devices of each other, and thereby the data of a memory card in a card reader of the netbook can be copied to a storage device of the information processing device, or the data of a memory card in a card reader of the information processing device can be copied to a storage device of the netbook.

To accomplish the above objectives, the present invention proposes a netbook synchronization chip device for data communication and power line connection between a netbook and an external device, comprising: a first USB interface, coupled to a USB host of the netbook; a second USB interface, coupled to the external device which can be a USB device or a device comprising a USB host; a memory unit for buffering transmission data and storing an application software and a firmware, wherein the application software can be downloaded and executed by the netbook and the external device to transform a peripheral device of the netbook or a peripheral device of the external device into a USB device with an accessible root directory, and allow the peripheral device commonly shared by the netbook and the external device via the first USB interface and the second USB interface; and a synchronization chip controller, used for identifying the external device and controlling the first USB interface and the second USB interface to perform data communication and power line connection between the netbook and the external device according to the firmware.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

The present invention can be more fully understood by reading the subsequent detailed description and examples with references made to the accompanying drawings, wherein:

FIG. 1 is a block diagram of a netbook synchronization chip according to a preferred embodiment of the present invention.

FIG. 2 is a block diagram of a first application of a netbook synchronization chip according to a preferred embodiment of the present invention.

FIG. 3 is a block diagram of a second application of a netbook synchronization chip according to a preferred embodiment of the present invention.

FIG. 4 is a schematic diagram of a synchronization device according to an embodiment of the invention.

FIG. 5 is a schematic diagram of a synchronization device according to another embodiment of the invention.

FIG. 6 is a schematic diagram of a synchronization device according to another embodiment of the invention.

### DETAILED DESCRIPTION OF THE INVENTION

The present invention will be described in more detail hereinafter with reference to the accompanying drawings that show the preferred embodiment of the invention.

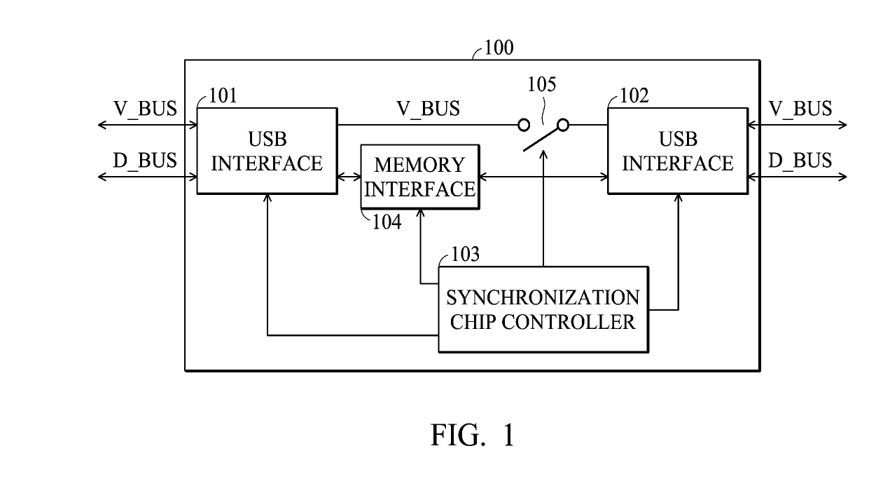

Please refer to FIG. 1, which shows a block diagram of a netbook synchronization chip according to a preferred embodiment of the present invention. As shown in FIG. 1, the netbook synchronization chip of the present invention, used for data communication or power line connection between a netbook and an external device, comprises USB interfaces 101-102, a synchronization chip controller 103, a memory unit 104 and a switch 105.

In the chip, the USB interface 101 is used for coupling to a USB host of the netbook. The USB interface 102 is used for coupling to the external device, which can be a USB device or an information processing device including a USB host. The information processing device can be, for example but not limited to, a personal computer.

The synchronization chip controller 103 can identify the external device and control the USB interfaces 101-102, the memory unit 104 and the switch 105 according to a firmware in the memory unit 104, to perform data transmission or power line connection between the netbook and the external device. When the external device is a USB device, the synchronization chip controller 103 can detect the pull-up resistance of a data line (D+ or D−) of D_BUS in the USB interface 102 (depending on the operating speed of the USB device, which can be classified into low speed, full speed and high speed) to identify the USB device. The synchronization chip controller 103 can drive the switch 105 to control the switching of a V_Bus power line. When the external device is a USB device, the synchronization chip controller 103 can drive the switch 105 to connect the V_Bus power line to the USB device to supply the operating power; when the external device is an information processing device, the synchronization chip controller 103 can connect the V_Bus power line to the netbook so that the netbook can obtain charging power from the information processing device.

The memory unit 104 is used to buffer transmission data and store an application software and a firmware, wherein the application software can be downloaded and executed by the netbook and the external device to transform peripheral devices of the netbook and of the external device into USB devices with accessible root directories, and make the peripheral devices commonly shared by the netbook and the external device via the first USB interface and the second USB interface. Besides, the application software can also be run by the netbook and the information processing device to transform the data format of the hard drive pertaining to, for example the WINDOWS operating system or the Linux operating system, to be compatible with a FAT32 format.

The switch 105 is used to determine the connection of the V_Bus power line between the USB interface 101 and the USB interface 102.

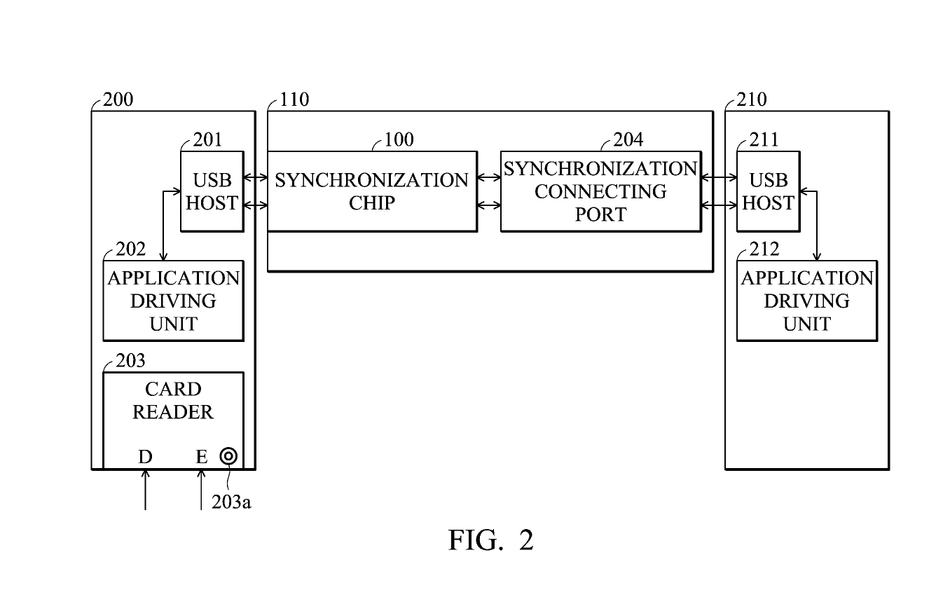

Please refer to FIG. 2, which shows a block diagram of a first application of a netbook synchronization chip according to a preferred embodiment of the present invention. As shown in FIG. 2, the first application of a netbook synchronization chip according to a preferred embodiment of the present invention comprises a synchronization chip device 110, a netbook 200 and a personal computer 210.

In the application, the synchronization chip device 110 comprises a synchronization chip 100 and a synchronization connecting port 204, wherein the synchronization connecting port 204 can be a USB type A socket for the external device to engage.

The netbook 200 comprises a USB host 201, an application driving unit 202 and a card reader 203. The USB host 201 is coupled to the USB interface 101 of the synchronization chip 100 to perform data transmission or power line connection.

The application driving unit 202 is coupled to the USB host 201 to execute the application software downloaded from the synchronization chip 100 to transform a netbook peripheral device, for example but not limited to a SATA hard drive or a graphic card, into a USB device with an accessible root directory, which can be accessed by the personal computer 210 via the synchronization chip device 110.

The card reader 203 has a fast-copy-button 203a for copying the data in a memory card, which is engaged with the card reader 203, to a storage device of the personal computer 210 through the USB host 201 and the synchronization chip device 110, under the control of the application driving unit 202. The personal computer 210 has a USB host 211 and an application driving unit 212.

The USB host 211 is coupled to the synchronization connecting port 204 of the synchronization chip device 110 to perform data transmission or power connection.

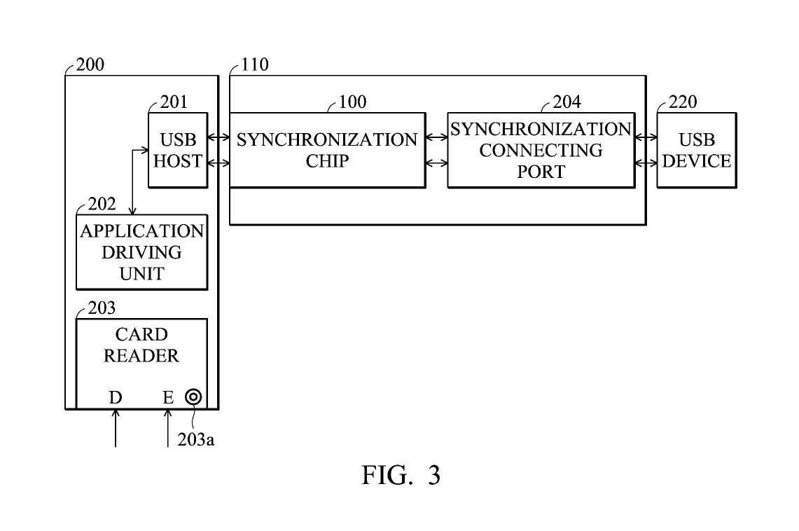

The application driving unit 212 is coupled to the USB host 211 to execute the application software downloaded from the synchronization chip 100 to transform a peripheral device of the personal computer 210, for example but not limited to a card reader, a SATA hard drive or a graphic card, into a USB device with an accessible root directory, which can be accessed by the netbook 200 via the synchronization chip device 110. Please refer to FIG. 3, which shows a block diagram of a second application of a netbook synchronization chip according to a preferred embodiment of the present invention. As shown in FIG. 3, the second application of a netbook synchronization chip according to a preferred embodiment of the present invention comprises a synchronization chip device 110, a netbook 200 and a USB device 220. In the application, the synchronization chip device 110 comprises a synchronization chip 100 and a synchronization connecting port 204, wherein the synchronization connecting port 204 can be a USB type A socket for the external device to engage.

The netbook 200 comprises a USB host 201, an application driving unit 202 and a card reader 203. The USB host 201 is coupled to the USB interface 101 of the synchronization chip 100 to perform data transmission or power line connection.

The application driving unit 202 is coupled to the USB host 201 to execute the application software downloaded from the synchronization chip 100 to transform a netbook peripheral device, for example but not limited to a SATA hard drive or a graphic card, into a USB device with an accessible root directory, which can be accessed by the personal computer 210 via the synchronization chip device 110.

The card reader 203 has a fast-copy-button 203a for copying the data in a memory card, which is engaged with the card reader 203, to the USB device 220 through the USB host 201 and the synchronization chip device 110, under the control of the application driving unit 202.

The USB device 220 is coupled to the synchronization connecting port 204 of the synchronization chip device 110 to perform data transmission or power connection.

Therefore, through the implementation of the netbook synchronization chip device of the present invention, a solution for a netbook to obtain external charging power and synchronize its data with an external device, without increasing its form factor, is provided and has indeed conquered the disadvantages of the prior art.

According to the described paragraphs, it is obvious that one feature of the invention is to transform the peripheral device, connected to the netbook or computer, into a USB device; thus, the peripheral device can be directly controlled by another electronic device. Furthermore, the invention can provide an easy way to share the peripheral devices connected to the computer with other mobile electronic devices or share the peripheral devices connected to the mobile electronic devices to the computer. The following paragraphs focus on the transformation of a peripheral device connected to the electronic device, such as a computer or mobile electronic devices, and the data transmission control or power transmission control between the electronic device and the transformed peripheral device.

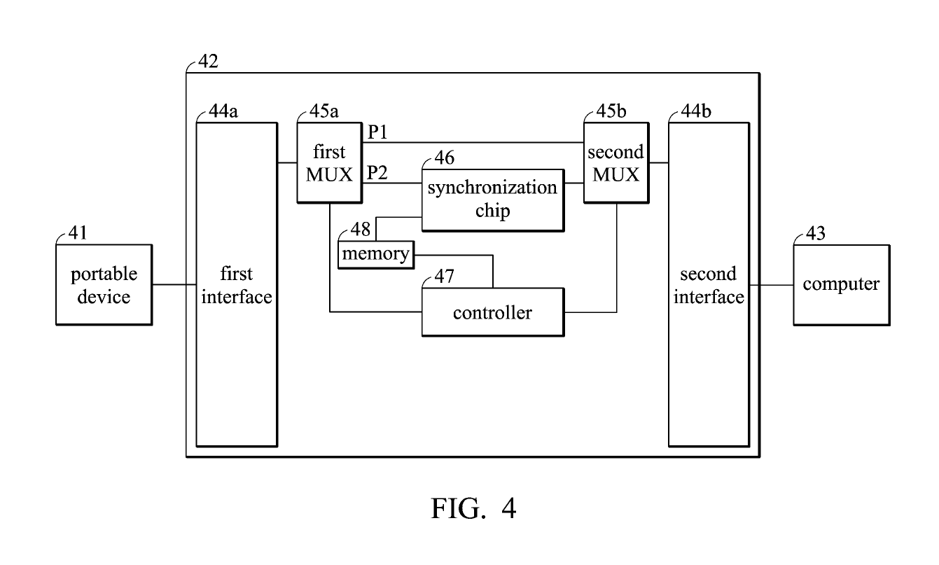

FIG. 4 is a schematic diagram of a synchronization device according to an embodiment of the invention. The synchronization device 42 is connected to a portable device 41 and a computer 42 via a first interface 44a and a second interface 44b respectively. The first multiplexer 45a is coupled to the first interface 44a, the second multiplexer 45b and the synchronization chip 46. The second multiplexer 45b is coupled to the second interface 44b, the first multiplexer 45a and the synchronization chip 46. The first multiplexer 45a and the second multiplexer 45b are controlled by the controller 47 to form a data transmission path between the portable device 41 and the computer 42. In this embodiment, only the data transmission path in the synchronization device 42 is discussed. When the controller 47 selects a first path P1 for transmitting data between the portable device 41 and the computer 43, the portable device 41 is regarded as a peripheral device of the computer 43 and is controlled by the computer 43. The controller 47 controls the first multiplexer 45a and the second multiplexer 45b to establish the first path P1 between the portable device 41 and the computer 42. From the perspective of the computer 43, the portable device 41 may be merely regarded as a storage device. The computer 43 transmits and stores data to the portable device 41, retrieves data from the portable device 41 or executes a synchronization process or program with the portable device 41 or a specific folder of the portable device 41.

When the controller 47 selects a second path P2, the synchronization chip 46 or the controller 47 transmits an application program stored in the memory 48 to the portable device 41 and the computer 43. The computer 43 receives and executes the application program to transform at least one peripheral device connected to the computer 43 into a USB device and the transformed USB device can be accessed by the portable device 41. The portable device 41 receives and executes the application program to transform at least one peripheral device connected to the portable device 41 into other USB device and the transformed USB device can be accessed by the computer 43. Note that the operating system of the computer 43 may be different from the operating system of the portable device. Therefore, the application program may be compatible with both the operating system of the portable device 41 and the computer 43. In other embodiments, the memory 48 stores a plurality of application programs compatible with different operating systems. The synchronization chip 46 or the controller 47 first determines the operating systems of the portable device 41 and the computer 43 and transmits a corresponding application program to the portable device 41 and the computer 43 respectively.

In other embodiments, when the portable device 41 and the computer 43 are connected to the synchronization device 42, the synchronization chip 46 or the controller 47 automatically transmits an application program stored in the memory 48 to the portable device 41 and the computer 43. When the computer 43 executes the application program to transform a first peripheral device into a first USB device, a control interface of the portable device 41 shows an icon corresponding to the first USB device. When the portable device 41 accesses or controls the first USB device, a select signal is transmitted to the controller 47 to select the second path P2. If the controller 47 does not receive the select signal, the controller 47 selects the first path P1.

In another embodiment, the computer 43 transmits a control instruction to the controller 47 and the controller 47 executes the application program accordingly to transform the peripheral device connected to the computer 43 into a first USB device. Simultaneously, the controller 47 grants the access right of the first USB device to the portable device 41, thus, the portable device 41 can directly access the first USB device. If the controller 47 does not grant the access right of the first USB device to the portable device 41, the portable device 41 can not access the first USB device. Furthermore, when the controller 47 grants the access right of the first USB device to the portable device 41, an icon or a message is then shown on a display of the portable device 41 to inform a user of the portable device 41 that the first USB device can be accessed by the portable device. If the controller 47 does not grant the access right of the first USB device to the portable device 41, the portable device 41 will not recognize the first USB device.

The operation of the application program is discussed in the following. For example, a printer, a card reader and a keyboard are connected to the computer 43 via an I/O interface. The computer 43 transforms the printer, the card reader and the keyboard into USB devices with accessible root directories. The printer, the card reader and the keyboard may be connected to the computer 43 via a USB interface and may be also called USB devices. However, the disclosed USB devices have different meanings. In this application, the USB device means that it can be accessed by the electronic device which is not directly connected to the USB device. For example, the computer 43 transforms the printer into a USB device with an accessible root directory, and the portable device 41 can therefore directly control the printer via the synchronization device 42. From the perspective view of the portable device 41, the printer connected to the computer 43 is regarded as a peripheral device virtually connected to the portable device 41. In another example, the computer 43 transforms the keyboard into the USB device, and a user can input data via the keyboard to the portable device 41. In another embodiment, a button is applied to the synchronization device 42, and when a user presses the button, a control signal is generated and transmitted to the computer 43 to transform the peripheral device connected to the computer 43 into the USB device that can be accessed and controlled by the portable device 41. In another embodiment, a synchronization button is set on the synchronization device 42, and when the synchronization button is pressed, the computer 43 synchronizes with the portable device 41 or a specific folder of the portable device 41.

The accessible root directory is a key part of the invention that allows the transformed peripheral device to be accessed by other devices. Each of the transformed peripheral devices may have a corresponding accessible root directory and data, wherein commands, requests or instructions which are transmitted to the transformed peripheral device are temporality stored in the corresponding accessible root directory. In other embodiments, all of the transformed peripheral devices share the same accessible root directory.

In other embodiments, the portable device 41 may connect to other peripheral device, such as camera kit or keypad, and the computer 43 can access the peripheral device directly. For example, a camera kit is connected to the portable device 41, and the portable device 41 transforms the camera kit into a USB device with an accessible root directory. From the perspective view of the computer 43, the camera kit is regarded as a peripheral device virtually connected to the computer 43. In the present technology, some kinds of portable devices can be regarded as a camera or an external storage device when connecting to a computer, but it is different from the present invention. The conventional technology shares only the built-in or embedded electronic devices, such as a camera module or storage devices, of a portable device with the computer that the portable device is physically connected to. Because vendors of the conventional portable device know information and configurations of the built-in or embedded electronic devices or module, the vendors may share the built-in or embedded electronic devices via configurations or a firmware. The conventional technology cannot share peripheral devices connected to the portable device to other electronic devices, such as the computer. In the present application, the invention provides a sharing mechanism for sharing a peripheral device, which is connected to the portable device 41, to the computer 43 via a synchronization device 42. Assuming that the shared peripheral device is a keypad, when the keypad is transformed into a USB device by the portable device 41, the keypad is regarded as an input device of the computer 43. When the user types via the keypad, output signals of the keypad are transmitted to the computer 43 via the synchronization chip 46. When the computer 43 receives the output signals from the keypad connected to the portable device 41, the computer 43 analyzes the output signals and outputs corresponding characters that a user types via the keypad. In this embodiment, the application program stored in the memory 48 plays an important role for exchanging data or signals between the computer 43 and the portable device 41. In the previous description, it is mentioned that the application program stored in the memory 48 would be transmitted to both the portable device 41 and the computer 43. In the following paragraphs, the operation of the synchronization chip 46 is discussed.

The synchronization chip 46 plays a role for exchanging data or instructions between the computer 43 and the portable device 41. In other embodiments, the synchronization chip 46 can directly synchronize the portable device 41 with the computer 43.

The synchronization between the portable device 41 and the computer 43 is a two-way synchronization. Assuming that the computer 43 is connected to the synchronization device 42 via an USB interface and a keyboard connected to the computer 43 is transformed into a first USB device, the synchronization chip 46 transmits data or signal from the first USB device to the portable device via the first interface 44a. The synchronization chip 46 informs the portable device 41 that the transmitted signals are keyboard signals, and the portable device 41 decodes or analyses the received signals and shows corresponding characters on a display of the portable device 41. If the first interface 44a is not the USB interface, the synchronization chip 46 may further transform the received signal into a first signal that is compatible with the first interface 44a. In other embodiments, a data encryption mechanism may be applied in the synchronization chip 46 for the security of transmitted signal or data.

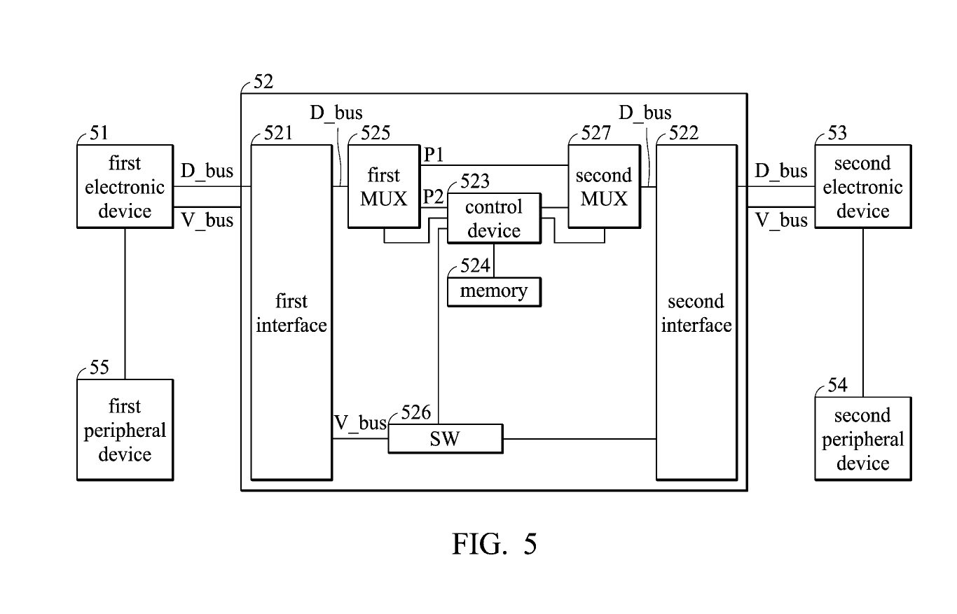

FIG. 5 is a schematic diagram of a synchronization device according to another embodiment of the invention. The synchronization device 52 is coupled between the first electronic device 51 and the second electronic device 53. The synchronization device 52 can exchange electrical power, data or signals between the first electronic device 51 and the second electronic device 53. Furthermore, the synchronization device 52 can share a peripheral device connected to one of the first electronic device 51 and the second electronic device 53 to another device. The first electronic device 51 may be a computer, a laptop, a netbook, a portable device or a smart phone. The second electronic device 53 may be a computer or a laptop. The synchronization device 52 is connected to the first electronic device 51 and the second electronic device 53 via a first interface 521 and a second interface 522 respectively. The switch 526 controls a power transmission between the first electronic device 51 and the second electronic device 53. When the switch 526 is turned on, the second electronic device 53 can charge the first electronic device 51. In other embodiments, a user can control the charging of the first electronic device 51 or the second electronic device 53 via a physical power control button (not shown in FIG. 5). The first electronic device 51 and the second electronic device 53 have two operating mode, a host mode and a slave mode. The host mode allows various USB peripheral devices connected to the first electronic device 51 or the second electronic device 53, and the first electronic device 51 or the second electronic device 53 can therefore charge the connected USB peripheral devices or another electronic device via the synchronization device 52. If the first electronic device 51 or the second electronic device 53 is operated in the slave mode, the first electronic device 51 and the second electronic device 53 cannot provide power to other peripheral devices or electronic devices.

When the first electronic device 51 synchronizes with the second electronic device 53 via the synchronization device 52, the control device 523 controls the first multiplexer 525 and the second multiplexer 527 to select the first path P1. From the perspective of the second electronic device 53, the first electronic device 51 may be merely regarded as a storage device. The second electronic device 53 transmits and stores data to the first electronic device 51, retrieves data from the first electronic device 51 or executes a synchronization process with the first electronic device 51 or a specific folder of the first electronic device 51.

In one embodiment, the control device 523 comprises a synchronization chip and an USB controller that can communicate with USB hosts of the first electronic device 51 and the second electronic device 53. The synchronization chip deals with synchronization between the first electronic device and the second electronic device 53, but not limit the invention thereto. Assuming the first peripheral device 55 is transformed into a first USB device by the first electronic device 51, the synchronization chip further transmits data, signals or requests between the first USB device and the second electronic device 53. The USB controller selects the first path P1 or the second path P2 according to a select signal from the first electronic device 51, the second electronic device 53 or a physical button or input device configured on the synchronization device 52.

When the control device 523 controls the first multiplexer 525 and the second multiplexer 527 to select a second path P2, the control device 523 first transmits an application program stored in the memory 524 to both the first electronic device 51 and the second electronic device 53. The second electronic device 53 receives and executes the application program to transform a second peripheral device 54 into a second USB device and the second USB device can be accessed by the first electronic device 51 accordingly. The first electronic device 51 receives and executes the application program to transform a first peripheral device 55 into a first USB device, such that the first USB device can be accessed by the second electronic device 53. Note that the operating system of the second electronic device 53 may be different from the operating system of the first electronic device 51. Therefore, the application program may be compatible with both the operating system of the first electronic device 51 and the second electronic device 53. In other embodiments, the memory 524 stores a plurality of application programs compatible with different operating systems. The control device 523 first determines the operating systems of the portable device 41 and the computer 43 and transmits a corresponding application program to the first electronic device 51 and the second electronic device 53 respectively.

The first USB device comprises a first accessible root directory and the second USB device comprises a second accessible root directory. The first accessible root directory and the second accessible root directory may not be of physically means and may not be embedded in the peripheral devices in most cases. The first accessible root directory and the second accessible root directory are generated after the first electronic device 51 and the second electronic device 53 execute the received application program from the synchronization device 52. The first accessible root directory and the second accessible root directory can be regarded as an access protocol or an access path that is different from the present access path.

When the second peripheral device 54 is accessed or controlled by the first electronic device 51, the first electronic device 51 transmits requests, commands or instructions to the synchronization device 52, and then the synchronization device 52 transmits the received commands or instructions to the second accessible root directory in the second electronic device 53 in the present case. The second peripheral device 54 may monitor the second accessible root directory and acquires the commands or the instructions when they are available. In other embodiments, the second electronic device 53 transmits the commands or instructions stored in the second accessible root directory to the second peripheral device 54. When the second peripheral device 54 responds to or transmits data to the first electronic device 51, the second peripheral device 54 transmits the data to the second accessible root directory first. The second electronic device 53 then transmits the data stored in the second accessible root directory to the first accessible root directory via the synchronization device 52. Finally, the first electronic device 51 or a controller (or called processor) of the first electronic device 51 acquires the data stored in the first accessible root directory.

Assuming that the second peripheral device 54 is a printer, when the second electronic device 51 wants to print a first data via the second peripheral device 54, the second electronic device 51 transmits the first data and the print instruction or command to the second peripheral device 54 via the synchronization device 52. The first data and the command are transmitted to the second electronic device via the synchronization device 52. The first data and the command are stored in the second accessible root directory via the application program executed by the second electronic device 53. Then, the second electronic device 53 transmits the first data and the command to the second peripheral device 54 to print. In other embodiments, the second peripheral device 54 monitors the second accessible root directory and when it detects that the second accessible root directory is storing data designated to the second peripheral device 54, the second peripheral device 54 acquires the data and executes or does corresponding operations. Note that the application program must be executed by the second electronic device 53, or else the described operation can not be implemented.

In this embodiment, the synchronization device 52 can transfer power from the second electronic device 53 to the first electronic device 51. The switch 526 is controlled by the control device 523 and when the switch 526 is turned on, the power can be exchanged between the first electronic device 51 and the second electronic device 53. In other embodiments, the synchronization device 52 further comprises a button to control the switch 526. The power transfer direction can be determined by the user or according to the energy capacity of the batteries of both the first electronic device 51 and the second electronic device 53. If the second electronic device 53 is a notebook or a computer and the first electronic device 51 is a portable device, the second electronic device 53 charges the first electronic device 51 via the synchronization device 52 when the energy capacity of the first electronic device 51 is lower than a predetermined level, such as 100% or 50%. In other embodiments, when the second electronic device 53 is powered by an external power, such as an adapter or a voltage transformer connected to an AC power source, a power grid or an electricity network, the second electronic device 53 charges the first electronic device 51 via the synchronization device 52. In other embodiments, when both the first electronic device 51 and the second electronic device 53 are portable devices, the synchronization device 52 transfers power from the second electronic device 53 to the first electronic device 51 when the energy capacity of the battery of the second electronic device 53 is larger than the energy capacity of the battery of the first electronic device 51. Simply speaking, the synchronization device 52 equalizes the energy capacity of both the batteries of the first electronic device 51 and the second electronic device 53. In other embodiments, the synchronization device 52 comprises a button or a switch that directly controls the switch 526, and when both the first electronic device 51 and the second electronic device 53 are portable devices, the synchronization device 52 does not transfer power between the first electronic device 51 and the second electronic device 53 until the button or the switch is pressed or turned on.

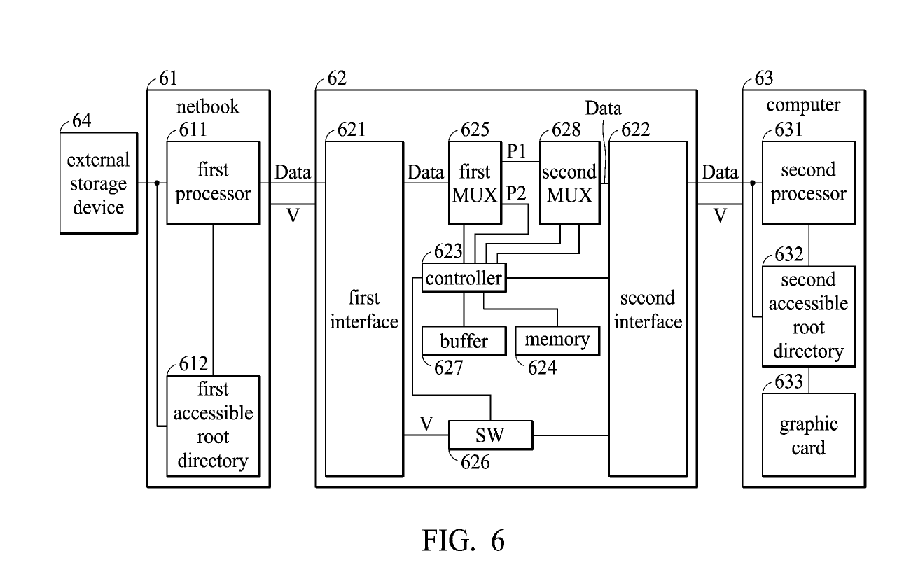

FIG. 6 is a schematic diagram of a synchronization device according to another embodiment of the invention. The synchronization device 62 is coupled between the netbook 61 and the computer 63. The synchronization device 62 can exchange electrical power, data or signals between the netbook 61 and the computer 63. Furthermore, the synchronization device 62 can share a peripheral device connected to one of the netbook 61 and the computer 63 to another device. The synchronization device 62 is connected to the netbook 61 and the computer 63 via a first interface 621 and a second interface 622 respectively. The switch 626 controls a power transmission between the netbook 61 and the computer 63. When the switch 626 is turned on, the computer 63 can charge the netbook 61. In other embodiments, a user can control the charging of the netbook 61 or the computer 63 via a physical power control button (not shown in FIG. 6). When the netbook 61 synchronizes with the computer 63 via the synchronization device 62, the controller 623 controls the first multiplexer 625 and the second multiplexer 628 to select the first path P1. In one embodiment, the controller 623 can be replaced by the control device 523 in FIG. 5. From the perspective view of the computer 63, the netbook 61 may be merely regarded as a storage device. The computer 63 transmits and stores data to the netbook 61, retrieves data from the netbook 61 or executes a synchronization process with the netbook 61 or a specific folder of the netbook 61.

When the controller 623 controls the multiplexer 623 to select a second path, the controller 623 first transmits an application program stored in the memory 624 to both the first electronic device 61 and the second electronic device 63. In this embodiment, the computer 63 shares a graphic card 633 to the netbook 61 and the netbook 61 shares an external storage device 64 to the computer 63. The first processor 611 executes the application program to transform the external storage device 64 into a first USB device and creates a first accessible root directory 612. The second processor 631 executes the application program to transform the graphic card 633 into a second USB device and creates a second accessible root directory 632.

When the netbook 61 transmits a first video data to the second USB device for processing, the controller 623 controls the multiplexer 625 to select the path P2. The controller 623 transfers the first video data to the computer 63 and the buffer 627 for buffering the first video data. The first video data is transmitted to the second accessible root directory 632 directly or via the second processor 631, and then the graphic card 633 processes the first video data. After processing, the graphic card 633 transmits the processed result to the netbook 61. The processed result is first stored in the second accessible root directory 632 and the graphic card 633 informs the second processor 631 to acquire the processed result. The second processor 631 transmits the processed result to the synchronization device 62. When the controller 623 receives the processed result, the controller 623 transmits the processed result to the first processor 611.

When the computer backs up a second data to the external storage device 64, the controller 623 controls the multiplexer 625 to select the path P2. The second data is first transmitted to the synchronization device 62. The second data may be buffered by the buffer 627. The controller 623 transmits the second data to the first accessible root directory 612 directly. The first processor 611 then stores the second data to the external storage device and transmits a backup result to the computer 63.

In this embodiment, the synchronization device 62 does not transfer the electricity power between the netbook 61 and the computer 63. Only when one of the electronic devices connected to the synchronization device 62 is a portable or mobile device, will the switch 626 be able to be turned on.

According to the described paragraphs, the proposed synchronization device provides two data transmission paths. One path is for the data transmission between two electronic devices connected to the proposed synchronization device, and another path is for one electronic device to access a peripheral connected to another electronic device. The proposed synchronization device further provides a power transmission path to charge a portable device connected to the synchronization device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A synchronization device for a first electronic device and a second electronic device, comprising:
a first interface coupled to the first electronic device;
a second interface coupled to the second electronic device; and
a memory, coupled to the first interface and the second interface, and storing an application program, wherein when the application program is executed, a peripheral device connected to the first electronic device is transformed into a first USB device that can be directly accessed by the second electronic device.

2. The synchronization device as claimed in claim 1, further comprising:
a controller coupled to the memory; and
a first multiplexer, controlled by the controller and coupled to the first interface;
a second multiplexer, controlled by the controller and coupled to the second interface and the first multiplexer, wherein when the first USB device is accessed by the second electronic device, the controller controls the first multiplexer and the second multiplexer to establish a first data transmission path between the second electronic device and the first USB device.

3. The synchronization device as claimed in claim 2, wherein when the first USB device is not accessed by the second electronic device, the controller controls the first multiplexer and the second multiplexer to establish a second data transmission path between the second electronic device and the first electronic device.

4. The synchronization device as claimed in claim 1, further comprising a controller, wherein when the controller receives a data designated to the first USB device from the second electronic device, the controller transmits the data to a first accessible root directory corresponding to the first USB device.

5. The synchronization device as claimed in claim 4, wherein the first accessible root directory is generated when the first electronic device transforms the peripheral device into the first USB device.

6. The synchronization device as claimed in claim 1, further comprising a controller, wherein when the first electronic device and the second electronic device are connected to the synchronization device, the controller transmits the application program to both the first electronic device and the second electronic device, and the first electronic device executes the application program to transform the peripheral into the first USB device.

7. The synchronization device as claimed in claim 1, further comprising a switch, wherein when the switch is turned on, a power transmission path is established between the first electronic device and the second electronic device.
